(19) United States
(12) Patent Application Publication
(10) Pub. No.: US 2026/0185773 A1
(43) Pub. Date: Jul. 2, 2026

(54) RECIRCULATING-AIR INSTALLATION, TREATMENT INSTALLATION AND METHOD FOR OPERATING A RECIRCULATING-AIR INSTALLATION

(71) Applicant: Dürr Systems AG, Bietigheim-Bissingen (DE)

(72) Inventors: Oliver IGLAUER-ANGRIK, Stuttgart (DE); Kevin WOLL, Heilbronn (DE); Heiko DIETER, Besigheim (DE); Dietmar WIELAND, Waiblingen (DE)

(21) Appl. No.: 18/860,448

(22) PCT Filed: May 23, 2023
(86) PCT No.: PCT/DE2023/100377

§ 371 Date: Oct. 25, 2024

(30) Foreign Application Priority Data
May 24, 2022 (DE) 10 2022 113 071.1

(51) Int. Cl. F26B 21/20; F26B 25/00

(52) U.S. Cl. CPC F26B 21/20; F26B 25/007

(57) ABSTRACT

The present invention relates to a recirculating-air installation (104), in particular for a treatment installation (100) for treating workpieces, wherein the recirculating-air installation (104) comprises the following:—a plurality of local recirculating-air modules (112), by means of which local recirculating-air flows (114) can be supplied to, passed through and removed from a treatment chamber (106), wherein the local recirculating-air flows (114) each flow through the treatment chamber (106) multiple times; and—a global recirculating-air ducting (120), by means of which a global recirculating-air flow (122) can be removed from the plurality of local recirculating-air modules (112) and/or the treatment chamber (106), can be conditioned by means of a conditioning device (126) and can be supplied again to at least one of the plurality of local recirculating-air modules (112) and/or the treatment chamber (106).

### RELATED APPLICATION

This application is a national phase of international application No. PCT/DE2023/100377 filed on May 23, 2023, and claims the benefit of German application No. 10 2022 113 071.1 filed on May 24, 2022, which are incorporated herein by reference in their entirety and for all purposes.

### FIELD OF DISCLOSURE

Examples disclosed herein relate to a recirculating-air installation, and to a treatment installation comprising a recirculating-air installation according to disclosed examples. Examples disclosed herein also relate to a method for operating a recirculating-air installation.

### BACKGROUND

It is known from practice that, for the technical ventilation of treatment installations such as drying installations in the field of automotive bodywork, i.e. driers, the drier atmosphere containing solvents (exhaust air) is constantly exchanged for a solvent-free flow of fresh air. For this purpose, an exhaust-air volume flow is extracted from one or more sites on the treatment chamber, or drying tunnel, with the aid of an exhaust-air fan and supplied to a device for exhaust-air cleaning, usually a technical exhaust-gas cleaning installation (TAR). The purified volume flow—if a TAR is used—is available at a temperature of approximately 450° C. for heating the drier. The individual treatment-chamber sections, or drying sections, are heated via clean-gas heat exchangers, while the clean-gas flow cools down along the clean-gas chain. Finally, the clean-gas flow passes through a fresh-air heat exchanger and then leaves the treatment installation at a temperature of, for example, 130° C., via the corresponding roof of the installation. The minimum exhaust-air volume flow is determined according to the standard on the basis of the lower explosion limit, but in practice is correspondingly higher, such that the energy requirement of the drying installation can be covered by the enthalpy of the clean gas.

As an alternative to TAR-purified drier systems, regenerative thermal oxidizers (RTO) may also be used. In the case of such systems, the output temperature of the clean gas from the RTO is approximately 20 K to 40 K above the intake temperature, and therefore significantly lower than in the case of a TAR. The clean-gas flow is therefore not suitable for heating the individual treatment-chamber sections, or drier zones, but is generally only used to preheat fresh air. Again, a clean-gas volume flow of usually over 100° C. is obtained, which is removed via the roof of the installation. Heat is supplied to the individual drier sections by individual burners or electric heating devices.

In neither case is there any physical return of purified exhaust air into the drying process.

The large enthalpy flow of the clean gas can only be partially recovered by the heat exchangers downstream in the clean-gas chain. A very large proportion of the input energy leaves the installation unutilized, via the roof, with the clean-gas flow.

The direct return of combustion products into the drying process has since been abandoned, as combustion with natural gas may produce various combustion products (NOx, sulfur compounds, etc.) that can be critical to the process.

### SUMMARY

An example disclosed herein is based on the object of providing a recirculating-air installation that allows efficient operation with reduced exhaust air.

This object is achieved according to examples disclosed herein by a recirculating-air installation having the features according to claim 1.

The recirculating-air installation is in particular a recirculating-air installation for a treatment installation for treating workpieces, in particular for drying vehicle bodies.

The recirculating-air installation comprises the following:
a plurality of local recirculating-air modules, by means of which local recirculating-air flows can be supplied to, passed through and removed from a treatment chamber, wherein the local recirculating-air flows each flow through the treatment chamber multiple times; and
a global recirculating-air ducting, by means of which a global recirculating-air flow can be removed from the plurality of local recirculating-air modules and/or the treatment chamber, can be conditioned by means of a conditioning device and can be supplied again to at least one of the plurality of local recirculating-air modules and/or the treatment chamber.

An example disclosed herein is based on the idea that, in order to reduce the energy loss of the exhaust-air flow, or clean-gas flow, removed via the roof, the exhaust-air volume flow extracted from the treatment chamber, or drying tunnel, is supplied to a special device for the purpose of purification and then at least partially ducted back into the process as purified recirculating air. The device for exhaust-air cleaning may be an electrically operated, flameless RTO.

It is particularly advantageous that this purely electrical heating of the gas volume flow does not introduce any foreign substances from the gas cycle, as is the case with purification using a TAR or a conventional RTO. Moreover, there is no risk of unburned gas flooding the treatment installation, or drier, and causing an explosion hazard.

Since there is a reduced clean-gas enthalpy loss via the roof, a significant energy saving is achieved. Moreover, the cross-section of the clean-gas ducting, or exhaust-air ducting, can be reduced, or a clean-gas ducting, or exhaust-gas ducting, via the roof can be avoided entirely, for example, if the global recirculating air is fully recirculated.

As a result of the global recirculating air being returned, a fresh-air heat exchanger can also be reduced in size, which also reduces the corresponding investment costs.

It should be understood that the treatment chamber may comprise a pretreatment chamber and/or a post-treatment chamber.

Further, with the recirculating-air installation according to examples disclosed herein, it is also possible to operate the installation in standby mode, in which the clean-gas enthalpy loss via the roof is almost zero.

Moreover, hot water can preferably be saved in the post-treatment chamber, or the cooling zone.

In one design of examples disclosed herein, it may be provided that the conditioning device is or comprises a conditioning device for conditioning, in particular for cleaning, the global recirculating air flow, wherein the conditioning device is or comprises a thermal conditioning device, in particular a purely electrically operated, preferably flameless, regenerative thermal oxidizer.

It may be beneficial if the RTO has an electric heating device for conditioning the global recirculating air flow and can also be operated autothermally if the solvent concentration has exceeded a particular limit value.

In the case of an autothermal reaction, for example with a solvent concentration of 1 g/m³, a temperature gain of approximately 20 K can be achieved, the temperature gain increasing with increasing solvent concentration. The RTO in this case may preferably have a catalytic effect.

Advantageously, following the conditioning, no process-critical reaction products are returned to the global recirculating air flow.

In one design of examples disclosed herein, it may be provided that the thermal conditioning device is or comprises an electric heating device, wherein it is preferably provided that thermal conditioning is effected exclusively by direct electrical heating, in particular electrical resistance heating, and/or by exothermic conversion of components of the global recirculating-air flow.

The conditioning device preferably comprises a fan for conveying the global recirculating-air flow.

In one design of examples disclosed herein, it may be provided that the conditioning device is provided and/or realized independently of a removal device for removing exhaust air, in particular spatially separated from an exhaust-air line that serves to remove exhaust air from the recirculating-air installation.

In one design of examples disclosed herein, it may be provided that, by means of the local recirculating-air modules, local recirculating-air flows can flow through different and/or mutually adjoining treatment-chamber sections of the treatment chamber, and that, by means of the global recirculating-air ducting, global recirculating air can be supplied to or adjacent to one or more local recirculating-air modules, and/or that, by means of the global recirculating-air ducting, recirculating air can be removed, as a global recirculating-air flow, from one or more other local recirculating-air modules.

Preferably, the global recirculating-air flow is supplied at the start and/or end of the treatment chamber, in particular into an inlet sluice and/or outlet sluice.

It is also conceivable, however, for the global recirculating air to be supplied directly to the local recirculating air modules at the input.

The exhaust air from the treatment-chamber sections is preferably removed at one of the middle treatment-chamber sections.

Thus, the global recirculating air supplied to the treatment chamber is supplied to the treatment-chamber sections, recirculated multiple times in these by means of the local recirculating-air modules and then removed for conditioning.

In one design of examples disclosed herein, it may be provided that the global recirculating-air ducting leads into one or more sluices of the treatment chamber for the purpose of fluidically separating an atmosphere in the treatment chamber from an environment of the recirculating-air installation.

It is advantageous in this case that the global recirculating-air flow can be supplied, in particular, as a sluice air flow or as part of the sluice air flow at the start and/or end of the treatment chamber, and can consequently be directed into the treatment chamber.

In one design of examples disclosed herein, it may be provided that the recirculating-air installation comprises one or more supplementary heating devices, which are provided in addition to the conditioning device and by means of which one or more sub-flows of the global recirculating-air flow can be heated.

Alternatively or additionally, it may be provided that the entire global recirculating-air flow can be heated.

Further, alternatively or additionally, it may be provided that one or more sub-flows of one or more local recirculating-air flows can be heated.

In one design of examples disclosed herein, it may be provided that an air flow passed through the conditioning device can be heated, at least temporarily, by means of the conditioning device to a temperature that causes a chemical conversion of substances, in particular solvents, contained in the air flow.

Preferably, the conditioning device is an RTO that enables the purification of solvent-containing and/or odorous exhaust air.

In contrast to conventional thermal exhaust-air purification systems, with this technology higher thermal efficiencies, of over 97%, may achieved by use of ceramic heat storage media. The fundamental principle of the RTO is based on the use of a plurality of combined reactor/heat storage beds. In this case the contaminated air flow, i.e. the global recirculating-air flow removed from the treatment chamber, is first preheated and then heated up to the required reaction temperature by a gas burner or an electric heating device, such that the thermal conversion of the noxious substances may be effected. Ceramic honeycomb bodies are generally used as reactor/heat storage beds. The waste heat from the reactor is then routed through a second bed with the exhaust air, the conditioned global recirculating air, and the heat is stored there. Once this storage bed has been heated up, the process-air flow ducting is switched over. The removed global recirculating air now passes the heated reactor/heating bed, is thereby heated up, and the noxious substances are then oxidized in the first bed. In further operation, the system switches over cyclically between these states. In this way, this method enables an autothermal operating state to be achieved even at very low concentrations of noxious substances in the exhaust air, i.e. the installation is heated by the exothermic energy released during the oxidation of the noxious substances, and does not require any further additional heating by primary energy.

Alternatively or additionally, it may be provided that an air flow passed through one or more supplementary heating devices can be heated by means of the one or more supplementary heating devices, in particular without substantial conversion of substances contained in the air flow.

In the one or more supplementary heating devices, the global recirculating-air flow is preferably only heated before it is supplied back to the treatment chamber.

In one design of examples disclosed herein, it may be provided that the recirculating-air installation comprises at least one heat exchanger, by means of which thermal energy contained in an abstracted global recirculating-air flow or in an exhaust-air flow can be transferred to a fresh-air flow supplied to the global recirculating-air flow.

In one design of examples disclosed herein, it may be provided that a cooled exhaust-air flow removed from the heat exchanger can be supplied to a fresh-air flow and/or a cooled exhaust-air flow assigned to a post-treatment chamber section.

In one design of examples disclosed herein, it may be provided that there is at least one filter means and/or sorption device, in particular an adsorption and/or absorption means, arranged downstream and/or upstream of the conditioning device, for the purpose of concentrating or de-concentrating at least one element, compound and/or mixture of the global recirculating-air flow.

The filtration process preferably separates suspended solids or suspended substances from a flow of liquid or gas. In the adsorption process, on the other hand, liquid or gas components are preferably bound to a solid surface such as, for instance, the surface of activated carbon or zeolites. Finally, in the absorption process, a flow of gas or air is preferably directed through a scrubbing liquid, thereby binding gas components that are to be absorbed.

Preferably, the filter means is a hot-zone filter, in particular a filter for sticky substances such as, for example, phosphates, a baffle filter or a filter cartridge, and the efficiency of the filter Means may be improved by pre-coating or cyclic filter cleaning. Alternatively or additionally, the filter means may be a chemical filter (chemisorption) or comprise burnt lime.

The absorption means is preferably an installation for flue-gas desulfurization.

The object is further achieved by a treatment installation comprising a recirculating-air installation according to examples disclosed herein.

It is preferably provided that the treatment installation can be supplied with a medium voltage of at least approximately 3 kV and/or at most approximately 8 kV, in particular 4,160 V to 6,600 V.

Preferably, all electrically operated heating components of the recirculating-air installation, or of the treatment installation, such as, among others, the preferably electrically operated supplementary heating devices and the conditioning device, can be supplied with a medium voltage of, for example, at least approximately 3 kV and/or at most approximately 8 kV, in particular 4,160 V to 6,600 V, instead of the usual 400 V. Although this may require special heating elements, entailing corresponding additional costs, it offers great savings potential, preferably in peripheral equipment, i.e. with regard to terminal connections, cables, etc. In addition, a substantially lower voltage transformation factor from the supply network is required, and this, among other things, reduces the size of the transformer station to the benefit of investment costs and saves space. Moreover, the terminal connection to an electrically operated heating component of such a medium voltage involves significantly smaller cable diameters.

Example disclosed herein are further based on the object of providing a method that enables a recirculating-air installation to be operated with reduced exhaust air.

This object is achieved according to examples disclosed herein by a method according to the independent method claim.

Preferably, in the case of the method for operating a recirculating-air installation, by means of a plurality of local recirculating-air modules, a plurality of local recirculating-air flows are supplied to, passed through and removed from a chamber to be ventilated, in particular a treatment chamber, wherein the local recirculating-air flows each flow through the treatment chamber multiple times. Further, preferably, by means of a global recirculating-air ducting, a global recirculating-air flow is removed from the plurality of local recirculating-air modules and/or the treatment chamber, conditioned and supplied again to at least one of the plurality of local recirculating-air modules and/or the treatment chamber.

The method preferably has individual features or a plurality of the features and/or advantages described in connection with the recirculating-air installation.

Preferably, the recirculating-air installation also has individual features or a plurality of the features and/or advantages described in connection with the method.

In one design of examples disclosed herein, it may be provided that the global recirculating-air flow is heated for conditioning thereof, in particular directly and/or exclusively by means of an electrical resistance heating and/or by exothermic conversion of components of the global recirculating-air flow.

In one design of examples disclosed herein, it may be provided that at least approximately 90%, in particular at least approximately 95 %, of a total volume flow of the global recirculating-air flow removed from the treatment chamber is conditioned and supplied again to the treatment chamber.

In one design of examples disclosed herein, it may be provided that the conditioning of the global recirculating-air flow is effected independently of a removal of exhaust air, in particular spatially separated from an exhaust-air line that serves to remove exhaust air from the recirculating-air installation.

In one design of examples disclosed herein, it may be provided that at least approximately the entire global recirculating-air flow removed from the local recirculating-air modules is thermally conditioned during each circulation within the global recirculating-air ducting, in particular without the use of additives or other introduction of substances into the global recirculating-air flow.

In one design of examples disclosed herein, it may be provided that the global recirculating-air flow is passed, at least partially or at least approximately entirely, through the conditioning device and is thereby heated, at least temporarily, up to a temperature that causes a chemical conversion of substances, in particular solvents, contained in the air flow, and that at least some of the heat temporarily contained in the global recirculating-air flow is recuperated, such that the global recirculating-air flow leaves the conditioning device at a temperature that is between an inlet temperature and a temporary maximum temperature.

In one design of examples disclosed herein, it may be provided that the global recirculating-air flow is passed, partially or at least approximately entirely, through one or more supplementary heating devices, and that the temperature of the global recirculating-air flow is thereby raised by at most approximately 20 K, in particular at most approximately 15 K, in particular without intermediate overheating and resultant conversion of substances contained in the recirculating-air flow.

Further preferred features and/or advantages of examples disclosed herein are provided by the following description and the illustrative representation of exemplary embodiments.

### BRIEF DESCRIPTION OF THE DRAWINGS

FIG. 1 shows a schematic representation of a first embodiment of a treatment installation;

FIG. 2 shows a schematic representation of a second embodiment of a treatment installation;

FIG. 3 shows a schematic representation of a third embodiment of a treatment installation;

FIG. 4 shows a schematic representation of a fourth embodiment of a treatment installation;

FIG. 5 shows a schematic representation of a fifth embodiment of a treatment installation;

FIG. 6 shows a schematic representation of a sixth embodiment of a treatment installation;

FIG. 7 shows a schematic representation of a seventh embodiment of a treatment installation;

FIG. 8 shows a schematic representation of an eighth embodiment of a treatment installation;

FIG. 9 shows a schematic representation of a ninth embodiment of a treatment installation;

FIG. 10 shows a schematic representation of a tenth embodiment of a treatment installation;

FIG. 11 shows a schematic representation of an eleventh embodiment of a treatment installation; and

FIG. 12 shows a schematic representation of a twelfth embodiment of a treatment installation.

In all figures, elements that are the same or functionally equivalent are denoted by the same reference designations.

### DETAILED DESCRIPTION OF THE DRAWINGS

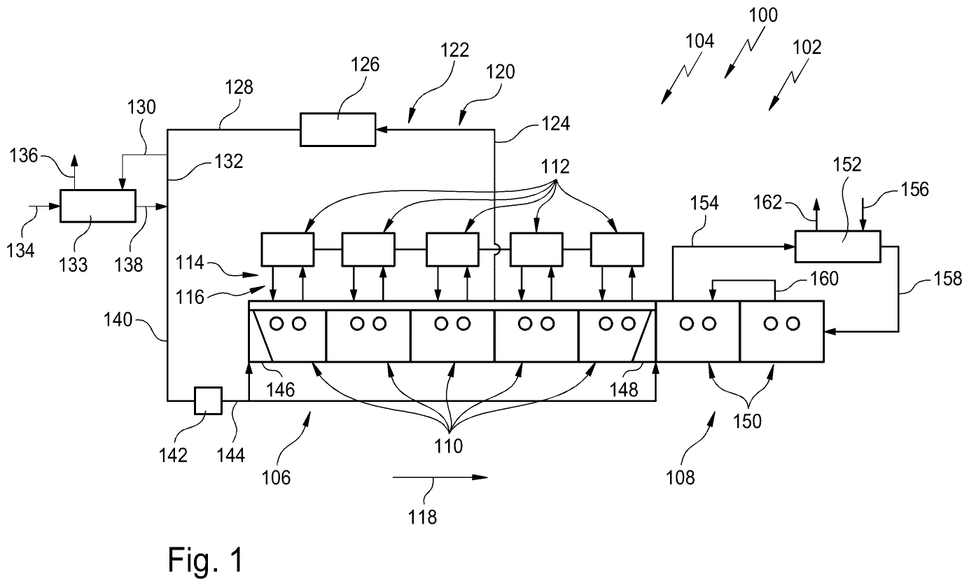

A first embodiment, represented in FIG. 1, of a treatment installation, designated as a whole by 100, serves to treat workpieces (not represented), in particular to dry vehicle bodies.

The treatment installation 100 is in particular a drier 102 for drying previously coated vehicle bodies.

The treatment installation 100 comprises a recirculating-air installation 104, a treatment chamber 106 and a post-treatment chamber section 108.

The treatment chamber 106 comprises a plurality of treatment-chamber sections 110.

The treatment-chamber sections 110 are assigned to a plurality of separate, local recirculating-air modules 112 of the recirculating-air installation 104.

The local recirculating-air modules 112 each circulate a local recirculating-air flow 114, in a local recirculating-air ducting 116, through the respectively assigned treatment-chamber section 110.

The local recirculating-air modules 112 preferably comprise a fan and a preferably electric heating device for heating the respective local recirculating-air flow 114.

The workpieces to be treated, in particular vehicle bodies, are conveyed through the treatment chamber 106 and the post-treatment chamber 108, along a direction of conveyance 118.

The recirculating-air installation 104 also comprises a global recirculating-air ducting 120 that guides a global recirculating-air flow 122.

The global recirculating-air flow 122 is removed from the treatment chamber 106 at the level of one of the middle treatment-chamber sections 110 and is then at least partially supplied back to it.

A global recirculating-air flow 124 removed at one of the middle treatment-chamber sections 110 is supplied to a conditioning device 126, arranged downstream of the treatment chamber 106, for conditioning.

The conditioning in the conditioning device 126 is preferably effected by means of an RTO, which is preferably an electrically operated, flameless RTO.

A global recirculating-air flow 128 conditioned in the conditioning device 126 is divided, downstream of the conditioning device 126, into an abstracted global recirculating-air flow 130 and a returned global recirculating-air flow 132.

The abstracted global recirculating-air flow 130 serves to transfer its thermal energy to a supplied fresh-air flow 134 in a heat exchanger 133.

The heat exchanger 133 is preferably an air-to-air heat exchanger such as, for example, a tube-bundle or plate heat exchanger, in which the removed global recirculating-air flow 130 is cooled down as much as possible in the transfer of the thermal energy to the supplied fresh-air flow 134, i.e. for example to 60° C., in order thus to keep as much thermal energy as possible in the treatment installation 100.

After flowing through the heat exchanger 133, the abstracted global recirculating-air flow 130 is either discharged to the environment, i.e. via the roof, as a cooled exhaust-air flow 136, or supplied to an exhaust-gas line in which further cleaning is effected.

The standard volume flow of the cooled exhaust-air flow 136 preferably corresponds to that of the supplied fresh-air flow 134, the fresh-air flow 134 being partly drawn in via the sluices and partly routed via the heat exchanger 133 (usually 500 Nm³/h intake per sluice). In particular, this standard volume flow is 2,000 Nm³/h.

The heat transfer from the abstracted global recirculating-air flow 130 to the supplied fresh-air flow 134 in the heat exchanger 133 results in a preheated fresh-air flow 138, which is supplied to the returned global recirculating-air flow 132 for refreshment.

The mixed global recirculating-air flow 140 is then heated in a supplementary heating device 142.

In the first embodiment, represented in FIG. 1, the heated global recirculating-air flow 144 is supplied to an inlet sluice 146 and/or an outlet sluice 148 of the treatment chamber 106.

As already mentioned, the returned global recirculating-air flow 132 that is mixed with the preheated fresh-air flow 138 is heated, as a mixed global recirculating-air flow 140, in the supplementary heating device 142, which supplementary heating device may be a combustion chamber, but is preferably an electric heating device. The heating brings the through-flowing global recirculating-air flow to a temperature that is favorable or suitable for sluice operation of the inlet sluice 146 and/or outlet sluice. The supplementary heating device 142 in this case uses rapid temperature regulation to compensate fluctuations in the output temperature from the conditioning device 126, which in RTO systems are caused by the cyclical process of switch-over between the states. The use of a downstream, preferably electrical supplementary heating device with low inertia and rapid controllability is therefore particularly advantageous.

After the heated global recirculating-air flow 144 is supplied to the treatment chamber 106, it is recirculated there multiple times by means of the local recirculating-air modules 112. The global recirculating-air ducting 120 is preferably a continuous process for conditioning the local recirculating-air flows 114 circulated in the treatment-chamber sections 110 and the local recirculating-air modules 112.

The removed global recirculating-air flow 124 that is supplied to the conditioning device 126 is preferably based on the amount of air required by the inlet sluice 146 and/or outlet sluice 148, this requirement being dependent, in particular, on the degree of utilization of the treatment installation 100.

The post-treatment chamber 108 adjoins the treatment chamber 106 in the direction of conveyance 118.

The post-treatment chamber section 108 comprises a plurality of post-treatment chamber sections 150.

Assigned to the post-treatment chamber section 108 there is a heat exchanger 152 by which the thermal energy contained in an exhaust-air flow 154 is transferred to a supplied fresh-air flow 156. More common, however, is a bypass ducting (not represented), by which a sub-flow of fresh air can be drawn in by the fresh-air intake.

A preheated fresh-air flow 158 is supplied from the heat exchanger 152 to one of the post-treatment chamber sections 150.

Realized between the post-treatment chamber sections 150 there is a cascade air ducting 160.

After at least some of the thermal energy has been transferred, the exhaust-air flow is removed, downstream of the heat exchanger 152, as a cooled exhaust-air flow 162.

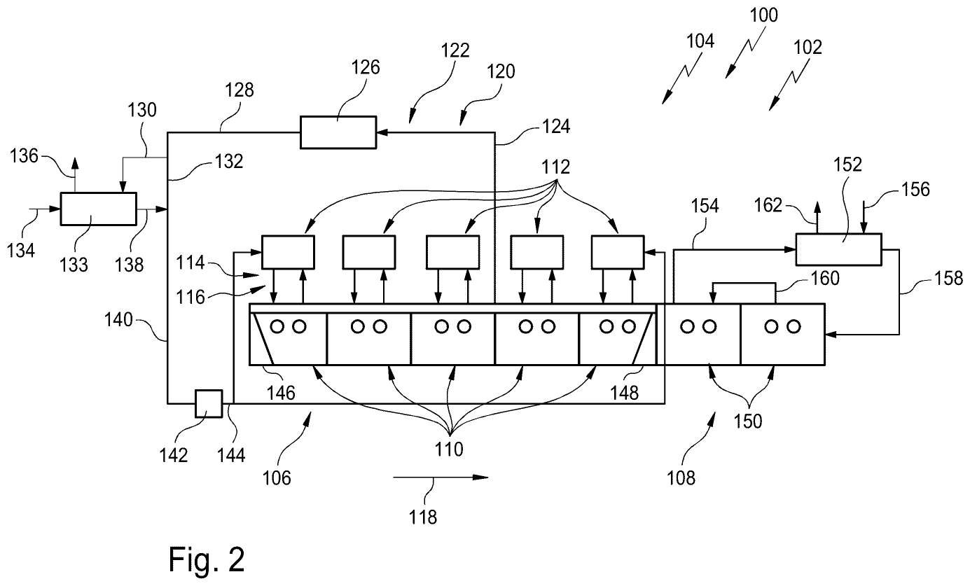

A second embodiment of the treatment installation 100 is represented in FIG. 2.

In the embodiment of the treatment installation 100 represented in FIG. 2, the global recirculating-air flow 144 heated in the supplementary heating device 142 is alternatively supplied directly to the local recirculating-air modules 112 arranged on the outside, i.e. to the local recirculating-air modules 112 that are assigned to the treatment-chamber sections 110 comprising the inlet sluice 146 and the outlet sluice 148.

The supply into the two local recirculating air modules 112 arranged on the outside is effected for reasons of balance, and for optimum flushing of the treatment chamber 106.

Also conceivable is supply into more than two recirculating-air modules 112.

In the case of the heated recirculating-air flow 144 being supplied to the local recirculating-air modules 112, the inlet sluice 146 and the outlet sluice 148 are operated as recirculating-air sluices.

It is to be understood that the returned, heated recirculating air that, due to the conditioning, corresponds at least approximately to a clean gas, can be supplied to the outer regions of the treatment chamber 106, i.e. in particular to the corresponding local recirculating-air modules 112 and/or the inlet sluice 146 and/or outlet sluice 148, and is then conveyed, in particular through the local recirculating air ducting 116, from both ends of the treatment chamber 106 toward the centre of the treatment chamber 106.

The standard volume flow of the heated global recirculating-air flow 144 is preferably 10000 Nm³/h.

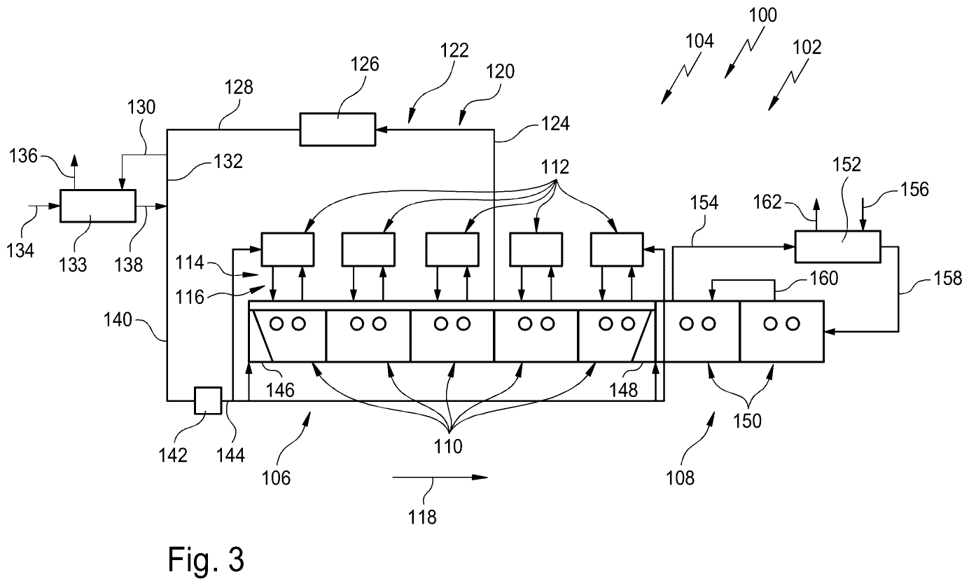

Consequently, the third embodiment of the treatment installation 100, represented in FIG. 3, shows a combination of the possibilities for supplying the heated recirculating-air flow 144, which is accordingly supplied to both the inlet sluice 146 and the outlet sluice 148, as well as to at least the two local recirculating-air modules 112 that in FIG. 3 are arranged on the outside.

The combined supply is particularly advantageous if large quantities of air are supplied, or circulate in the global recirculating-air ducting, i.e. if the quantity of air ducted in the global recirculating-air flow 122 is greater than the amount of air required by the inlet sluice 146 and outlet sluice 148.

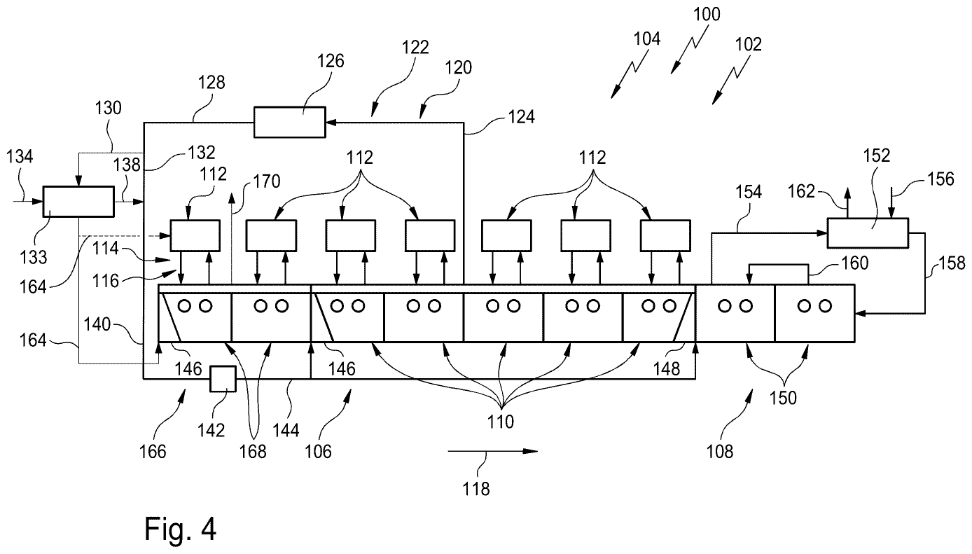

In the fourth embodiment of the treatment installation 100, represented in FIG. 4, the abstracted global recirculating-air flow 130, following the transfer of at least some of its thermal energy to the supplied fresh-air flow 134 in the heat exchanger 133, is not produced as cooled exhaust air, but is supplied as a supply-air flow 164 to a pretreatment chamber 166 that is arranged upstream of the treatment chamber 106 in relation to the direction of conveyance 118 and comprises one or more pretreatment chamber sections 168.

The pretreatment chamber sections 168 are likewise each assigned to a local air recirculation module 112.

The pretreatment chamber sections 168 arranged at the start of the pretreatment chamber 166 also have their own inlet sluice 146.

The supply-air flow 164 may be supplied to the inlet sluice 146 of the pretreatment chamber 166 and/or to one of the local recirculating-air modules 112 assigned to the pretreatment chamber sections 168.

Preferably between the two pretreatment chamber sections 168, or in the middle of a plurality thereof, an exhaust-air flow 170 may also be routed out via the roof or into an exhaust-gas line for cleaning, the standard volume flow of which is preferably 2,000 Nm³/h.

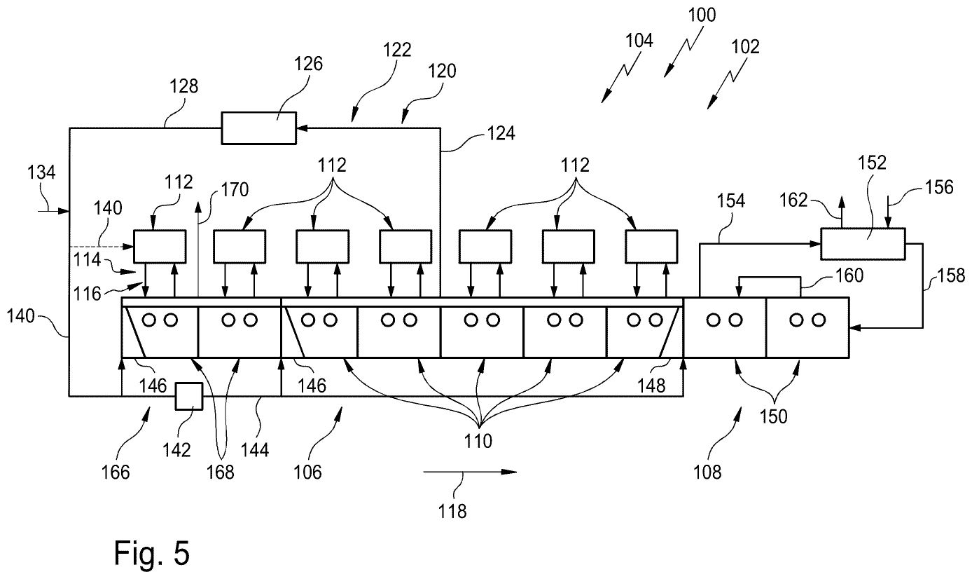

As an alternative to the fourth embodiment represented in FIG. 4, in a fifth embodiment of the treatment installation 100, which is represented in FIG. 5, the returned global recirculating-air flow 138 is not mixed with preheated fresh air from a fresh-air heat exchanger, but the supplied fresh-air flow 134 is mixed directly with the conditioned global recirculating-air flow 128.

Consequently, the mixed global recirculating-air flow 140 is supplied, without preheating, to the inlet sluice 146 of the pretreatment chamber 166 and/or to one of the local recirculating-air modules 112 assigned to the pretreatment chamber sections 168.

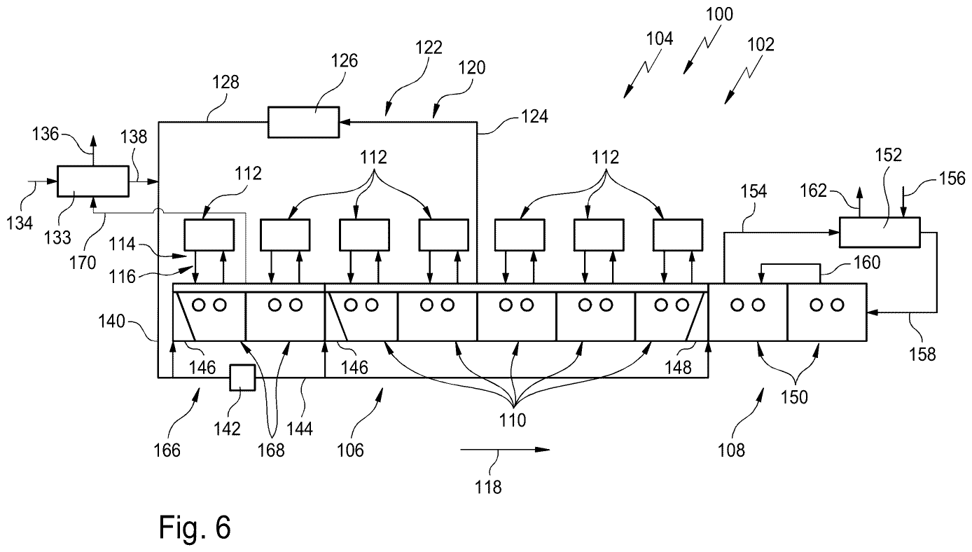

As a further alternative to the fourth and the fifth embodiment, FIG. 6 shows a sixth embodiment of a treatment installation 100, in which the exhaust-air flow 170 of the pretreatment chamber 166 is routed to the heat exchanger 132.

The thermal energy contained in the exhaust-air flow 170 is transferred in the heat exchanger 133 to the supplied fresh-air flow 134.

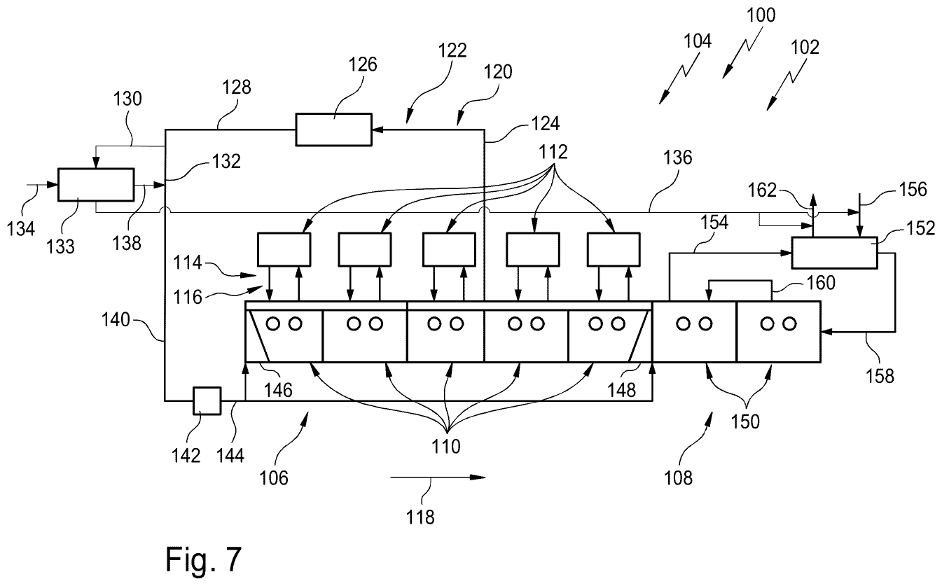

It may also be beneficial if the cooled exhaust-air flow 136 is not routed out of the treatment installation 100 via the roof, but—as represented in FIG. 7, in a seventh embodiment of the treatment installation 100—is supplied to the cooled exhaust-air flow 162 and/or the supplied fresh-air flow 156 of the heat exchanger 152 that assigned to the post-treatment chamber section 108.

The feeding of the cooled exhaust-air flow 136 into the region of the post-treatment chamber 150, which preferably forms a cooling zone, reduces the requirement for heating energy there, in particular in winter operation. In addition, this supply eliminates the need for an exhaust-air channel of the treatment installation 100 in order to route the exhaust air out via the roof. This is now routed out of the treatment installation 100 via the exhaust-air flow 162 of the post-treatment chamber 108.

If the post-treatment chamber section 108 has no thermal energy requirement, the cooled exhaust-air flow 136 associated with the global recirculating-air flow 122 may also be routed out, together with the exhaust-air flow 162 of the post-treatment chamber 108, via the roof with the aid of a bypass ducting.

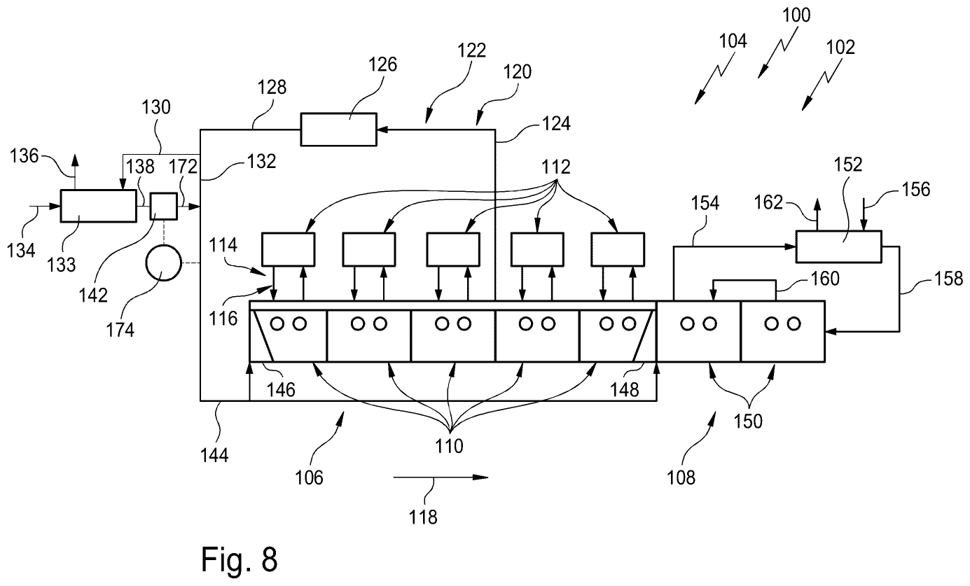

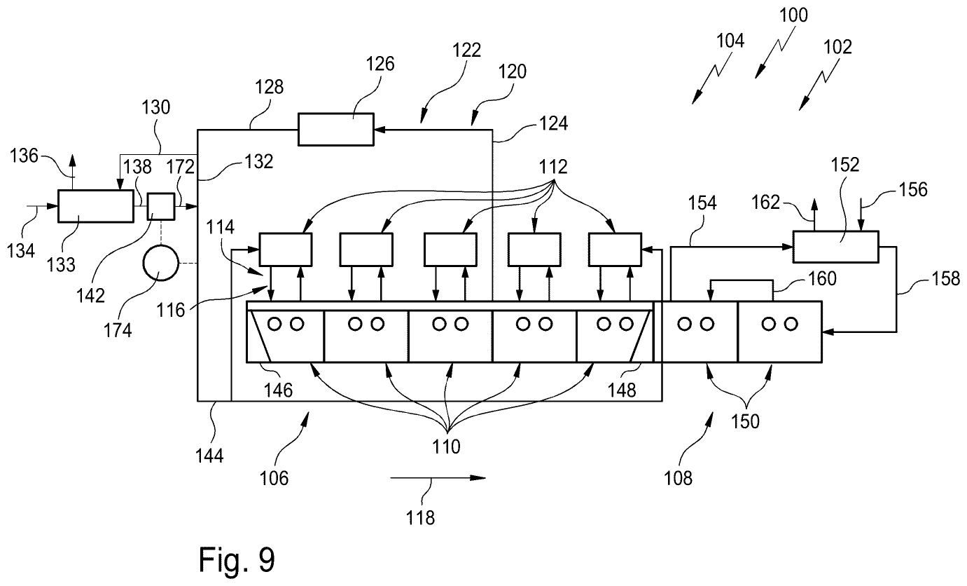

In an eighth and ninth embodiment of the treatment installation 100, represented in FIGS. 8 and 9 respectively, the preheated fresh-air flow 138 is first heated further by means of the supplementary heating device 142, which preferably is or comprises an electric heating device, before being admixed with the returned global recirculating-air flow 132, i.e. the supplementary device is arranged directly downstream of the heat exchanger 133 and not directly upstream of the treatment chamber 106 as in the first to seventh embodiments.

The preheated fresh-air flow 138 routed out from the heat exchanger 133 is heated by means of the supplementary heating device 142 to form a heated fresh-air flow 172 in such a way that, after being mixed with the returned global recirculating-air flow 132, it results in the heated global recirculating-air flow 144, which has the temperature suitable, or favorable, for the treatment chamber 106, or the sluices 146, 148.

In this case, the supplementary heating device 142 may be realized as a simple heating device, in particular without a protective sheath, as it comes into contact exclusively with the supplied fresh air and not with the global recirculating air.

Moreover, the supplementary device 142 may be connected to or have closed-loop controller 174 in order to control the temperature of the air flow by closed-loop control after the supplementary heating device 142 and/or after the heated fresh-air flow 172 has been admixed with the returned global recirculating-air flow 132.

Since the fluctuations in respect of the outlet temperature of the conditioned global recirculating-air flow 128 are cyclical and therefore easily predictable, the closed-loop controller 174 may be operated in a model-predictive manner, i.e. the output of the supplementary heating device 142 may be adapted in anticipation, thus avoiding in particular a situation in which defined limit values are reached and/or exceeded.

The heated global recirculating-air flow 144, after the admixing according to the eighth embodiment in FIG. 8, is supplied to the inlet sluice 146 and the outlet sluice 148 of the treatment chamber 106, whereas in the ninth embodiment in FIG. 9 it is supplied to at least two of the local recirculating-air modules 112.

It is also conceivable here that the heated global recirculating-air flow 144 is alternatively supplied both to the sluices 146, 148 and to at least one local recirculating-air module 112.

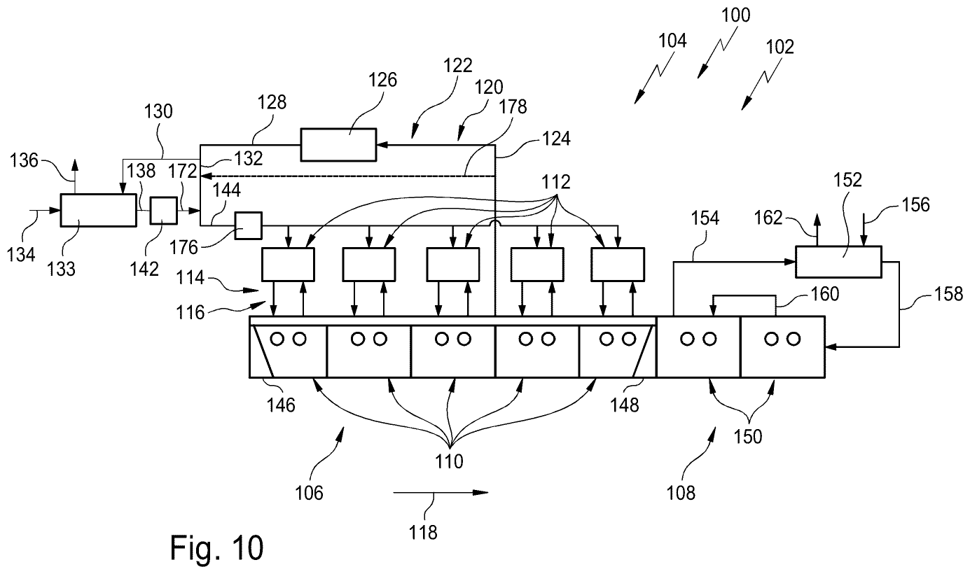

Represented in=n FIG. 10 is a tenth embodiment of the treatment installation 100, in which the abstracted global recirculating-air flow 130, in a manner comparable to the eighth and ninth embodiment, transfers its thermal energy in the heat exchanger 133 to a supplied fresh-air flow 134, and the heated fresh air then flows, as a preheated fresh-air flow 138, through the preferably supplementary heating device 142 in order to be further heated therein. The supplementary heating device 142 is not absolutely necessary because the air mixture is brought in any case to the wanted mixture temperature by the supplementary heating device 176.

The heated fresh-air flow 172 is then admixed with the returned global recirculating-air flow 132, thereby together forming a global recirculating-air flow 144.

In the tenth embodiment, the local recirculating-air modules 112 do not comprise their own heating devices, but instead there is a central heating device 176, in particular an electric heating device, arranged upstream of the local recirculating-air modules 112, that further heats the heated global recirculating-air flow 144 before the latter is supplied to the local recirculating-air flows 114 via the local recirculating-air modules 112 and is circulated into the local recirculating-air ducting 116.

The treatment installation 100 according to FIG. 10 also has a bypass recirculating-air ducting 178 that if necessary can guide the removed global recirculating-air flow 124 past the conditioning device 126.

The standard volume flow in the bypass recirculating-air ducting 178 is preferably in the range of from 0 to 10000 Nm³/h, depending on the requirements.

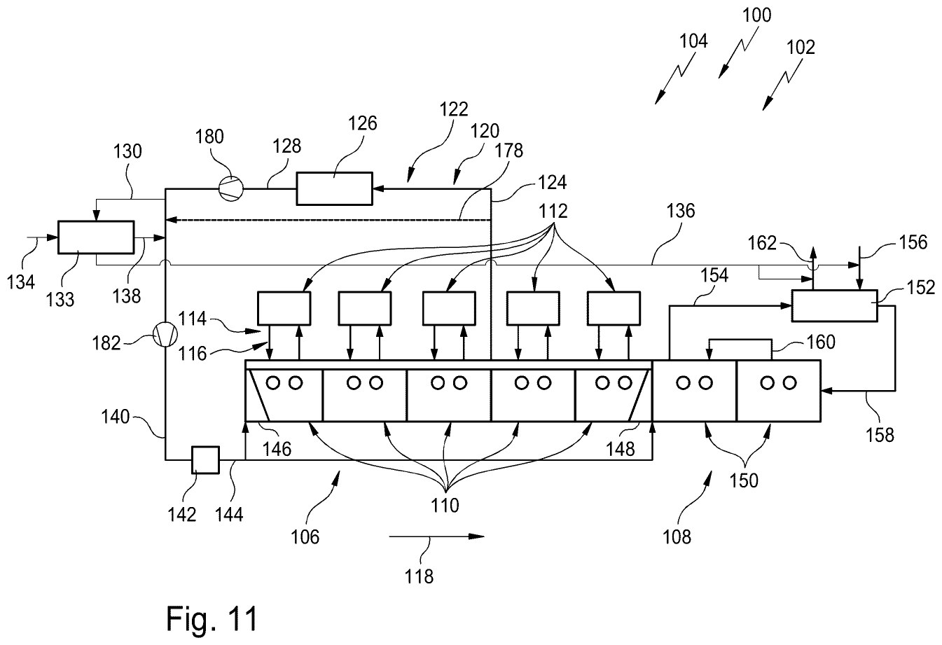

Represented in FIG. 11 is an eleventh embodiment of the treatment installation 100 that, like the tenth embodiment, has a bypass recirculating-air ducting 178 in order to guide the removed global recirculating-air flow 124 past the conditioning device 126.

The bypass recirculating air ducting 178 is advantageous, in particular, if the treatment installation is operated in an energy-efficient manner in the partial load range.

The global recirculating-air flow 122 that is routed to the conditioning device 126, which preferably is or comprises an electrically heated, flameless RTO, and the sub-flow that leaves the treatment installation 100, may be adapted depending on the load, for example by means of closed-loop flap control in the corresponding flow paths/guides. The fresh-air flow can also be adapted accordingly by means of a volume-flow measurement and a closed-loop control device.

Alternatively, as shown in FIG. 11, a constant volume flow may be provided for all load cases, but in this case only a sub-flow is supplied to the conditioning device 126 when the system utilization is reduced, and the remaining global recirculating-air flow is routed via the bypass recirculating-air ducting 178. Depending on the load case, the bypass may be adapted in stages.

Instead of a portion of recirculating-air volume that can be adjusted via the bypass, the entire global recirculating-air flow 122 to the conditioning device 126 may also be adapted in dependence on the work load.

In the global recirculating-air ducting 120, as shown in FIG. 11, there is a first fan 180 arranged downstream of the conditioning device 126 and a second fan 182 arranged downstream of the first fan 180, both of which serve, in particular, to extract global recirculated air from the treatment chamber 106.

It is also conceivable, however, for the first fan 180 to be arranged upstream of the conditioning device 126, while the second fan 182 is arranged downstream of the conditioning device 126.

The first fan 180 preferably drives the global recirculation air at a constant rate, while the throughput of the second fan 182 can be adapted to the air volume requirements of the sluices 146, 148.

In a manner similar to the seventh embodiment, the cooled exhaust air flow 136 is not removed via the roof, but is supplied to the exhaust-air flow 162 and/or to the fresh-air flow 156 of the heat exchanger 152 of the post-treatment chamber 108.

Although the introduction of foreign substances into the treatment installation 100 by natural gas is avoided in the case of conditioning with electrical heating in the conditioning device, contamination may still occur due to paint constituents and their combustion products that are released during the treatment of the workpieces in the treatment chamber 106.

Contamination of channels, or ductings, by the following substances is conceivable:
a) particles (silane compounds, phosphates); and/or
b) further chemical reaction products (crack products); and/or
c) sulfur compounds.

The operation of the treatment installation 100 according to examples disclosed herein with greatly reduced exhaust air also results in
d) an increase in the concentration of components such as CO₂; and/or
e) a decrease in the concentration of oxygen.

In particular, with respect to contaminants a) to c), the following measures may therefore be taken to clean the global recirculating-air flow 124 supplied to the conditioning device 126:
for a) hot-zone filters of the treatment installation 100, in particular a filter for sticky substances (e.g. phosphates), baffle filters, filter cartridges, pre-coating of filters and cyclic filter cleaning; and/or
for b) chemical filters (chemisorption) or burnt lime; and/or
for c) flue-gas desulphurization.

All devices a) to c) may be arranged before and/or after the conditioning cleaning device 126.

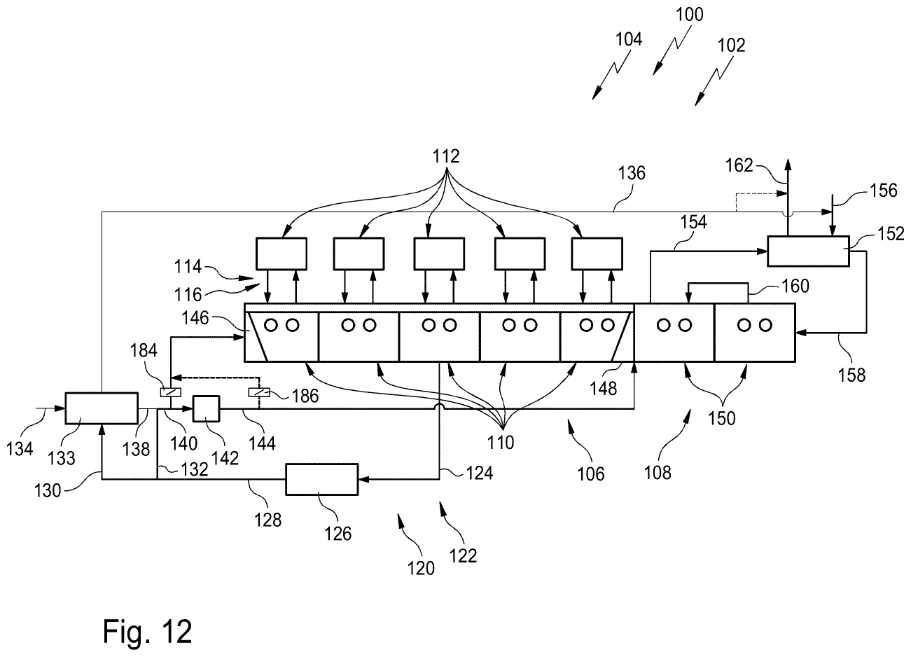

Shown in FIG. 12 is a twelfth embodiment of the treatment installation 100 that corresponds substantially to the seventh embodiment. In FIG. 12, however, for reasons of illustration the removed global recirculating-air flow 124 is removed downward, as a result of which the global recirculating-air flow 122 flows in a clockwise direction, unlike in the embodiments in FIGS. 1 to 11.

The global recirculating-air ducting 120 of the treatment installation 100 in FIG. 12 has a supply 184 upstream of the supplementary heating device 142, with which the mixed global recirculating-air flow 140 may be supplied to the inlet sluice 146 without additional heating.

The recirculating-air ducting 120 also has a return 186 downstream of the supplementary heating device, with which at least part of the heated global recirculating-air flow may be directed into the supply 184.

There is a first throttle valve 188 arranged in the supply 184, and a second throttle valve 190 arranged in the return 186.

By means of the supply 184 having open-loop and/or closed-loop flap control, and the return that likewise has open-loop and/or closed-loop flap control, two temperature levels can be set for the inlet and outlet of the treatment chamber 106, in particular for the heating-up of the treatment chamber 106; namely, a lower temperature level at the inlet with preferably maximum heating at the outlet.

During operation, this temperature difference may be adapted by open-loop control and/or closed-loop control of the throttle valves 188, 190.

Furthermore, the following options are known or at least conceivable for saving energy during the starting-up or shutting-down of the treatment installation 100:
a) optimized heating-up, i.e. without exhaust air; in this case, no exhaust-air flow is routed via the roof, the return is complete and all dampers for a sub-flow leaving the treatment installation are closed;
b) a break-time mode, likewise without exhaust air; and
c) a standby operation without exhaust air over, for example, two shifts, in which the roller shutters are closed and all fans in the recirculating air are lowered to a minimum output.

### List of Reference Designations

100 treatment installation
102 drier
104 recirculating-air installation
106 treatment chamber
108 post-treatment chamber section
110 treatment-chamber section
112 local recirculating-air module
114 local recirculating-air flow
116 local recirculating-air ducting
118 direction of conveyance
120 global recirculating-air ducting
122 global recirculating-air flow
124 removed global recirculating-air flow
126 conditioning device
128 conditioned global recirculating-air flow
130 abstracted global recirculating-air flow
132 returned global recirculating-air flow
133 heat exchanger
134 fresh-air flow
136 cooled exhaust-air flow
138 preheated fresh-air flow
140 mixed global recirculating-air flow
142 supplementary heating device
144 heated global recirculating-air flow
146 inlet sluice
148 outlet sluice
150 post-treatment chamber section
152 heat exchanger
154 exhaust-air flow
156 fresh-air flow
158 preheated fresh-air flow
160 recirculating-air flow
162 cooled exhaust-air flow
164 supply-air flow
166 pretreatment chamber
168 pretreatment chamber section
170 exhaust-air flow
172 heated fresh-air flow
174 closed-loop controller
176 central heating device
178 bypass recirculating-air ducting
180 first fan
182 second fan
184 supply
186 return
188 first throttle valve
190 second throttle valve

1. A recirculating-air installation for, optionally a treatment installation for treating workpieces, the recirculating-air installation comprising:
a plurality of local recirculating-air modules, by which local recirculating-air flows can be supplied to, passed through and removed from a treatment chamber, wherein the local recirculating-air flows each flow through the treatment chamber multiple times; and
a global recirculating-air ducting, by which a global recirculating-air flow can be removed from the plurality of local recirculating-air modules and/or the treatment chamber, can be conditioned by a conditioning device and can be supplied again to at least one of the plurality of local recirculating-air modules and/or the treatment chamber.

2. The recirculating-air installation as claimed in claim 1, wherein the conditioning device is or comprises a conditioning device for conditioning, optionally for cleaning, the global recirculating air flow, wherein the conditioning device is or includes a thermal conditioning device, optionally a purely electrically operated, preferably flameless, regenerative thermal oxidizer.

3. The recirculating-air installation as claimed in claim 2, wherein the thermal conditioning device is or comprises an electric heating device, wherein it is preferably provided that thermal conditioning is effected exclusively by direct electrical heating, in particular optionally electrical resistance heating, and/or by exothermic conversion of components of the global recirculating-air flow.

4. The recirculating-air installation as claimed in claim 1, wherein the conditioning device is provided and/or realized independently of a removal device for removing exhaust air, optionally spatially separated from an exhaust-air line that serves to remove exhaust air from the recirculating-air installation.

5. The recirculating-air installation as claimed in claim 1 wherein, by the local recirculating-air modules, local recirculating-air flows can flow through different and/or mutually adjoining treatment-chamber sections of the treatment chamber, and wherein, by the global recirculating-air ducting, global recirculating air can be supplied to or adjacent to one or more local recirculating-air modules, and/or wherein, by the global recirculating-air ducting, recirculating air can be removed, as a global recirculating-air flow, from one or more other local recirculating-air modules.

6. The recirculating-air installation as claimed in claim 1, wherein the global recirculating-air ducting leads into one or more sluices of the treatment chamber for the purpose of fluidically separating an atmosphere in the treatment chamber from an environment of the recirculating-air installation.

7. The recirculating-air installation as claimed in claim 1, wherein the recirculating-air installation includes one or more supplementary heating devices, which are provided in addition to the conditioning device and by which
a) one or more sub-flows of the global recirculating-air flow can be heated; and/or
b) the entire global recirculating-air flow; and/or
c) one or more sub-flows of one or more local recirculating-air flows can be heated.

8. The recirculating-air installation as claimed in claim 7, wherein
a) an air flow passed through the conditioning device can be heated, at least temporarily, by the conditioning device to a temperature that causes a chemical conversion of substances, optionally solvents, contained in the air flow; and/or
b) an air flow passed through one or more supplementary heating devices can be heated by the one or more supplementary heating devices, optionally without substantial conversion of substances contained in the air flow.

9. The recirculating-air installation as claimed in claim 1, wherein the recirculating-air installation includes at least one heat exchanger, by which thermal energy contained in an abstracted global recirculating-air flow or in an exhaust-air flow can be transferred to a fresh-air flow supplied to the global recirculating-air flow.

10. The recirculating-air installation as claimed in claim 9, wherein a cooled exhaust-air flow removed from the heat exchanger can be supplied to a fresh-air flow and/or a cooled exhaust-air flow assigned to a post-treatment chamber section.

11. The recirculating-air installation as claimed in claims 1, wherein there is at least one filter means and/or sorption device, optionally an adsorption and/or absorption means, arranged downstream and/or upstream of the conditioning device, for the purpose of concentrating or de-concentrating at least one element, compound and/or mixture of the global recirculating-air flow.

12. A treatment installation comprising a recirculating-air installation as claimed in claim 1.

13. The treatment installation as claimed in claim 12, wherein the treatment installation, optionally one or more or all electrically operated supplementary heating devices and/or a conditioning device can be supplied with a medium voltage of at least approximately 3 kV to at most approximately 8 kV, optionally 4,160 V to 6,600 V.

14. A method for operating a recirculating-air installation, the method comprising:
supplying to, passing through and removing from a chamber to be ventilated, by a plurality of local recirculating-air modules, a plurality of local recirculating-air flows, wherein the chamber is optionally a treatment chamber, and wherein the local recirculating-air flows each flow through the treatment chamber multiple times; and
removing, by a global recirculating-air ducting, a global recirculating-air flow from the plurality of local recirculating-air modules and/or the treatment chamber, the global recirculating-air flow conditioned and supplied again to at least one of the plurality of local recirculating-air modules and/or the treatment chamber.

15. The method as claimed in claim 14, wherein the global recirculating-air flow is heated for conditioning thereof, optionally directly and/or exclusively by an electrical resistance heating and/or by exothermic conversion of components of the global recirculating-air flow.

16. The method as claimed in claim 14, wherein at least approximately 90%, optionally at least approximately 95%, of a total volume flow of the global recirculating-air flow removed from the treatment chamber is conditioned and supplied again to the treatment chamber.

17. The method as claimed in claim 14, wherein the conditioning of the global recirculating-air flow is effected independently of a removal of exhaust air, optionally spatially separated from an exhaust-air line that serves to remove exhaust air from the recirculating-air installation.

18. The method as claimed in claim 14, wherein at least approximately the entire global recirculating-air flow removed from the local recirculating-air modules is thermally conditioned during each circulation within the global recirculating-air ducting, in particular without the use of additives or other introduction of substances into the global recirculating-air flow.

19. The method as claimed in claim 14, wherein the global recirculating-air flow is passed, at least partially or at least approximately entirely, through the conditioning device and is thereby heated, at least temporarily, up to a temperature that causes a chemical conversion of substances, optionally solvents, contained in the air flow, and wherein at least some of the heat temporarily contained in the global recirculating-air flow is recuperated, such that the global recirculating-air flow leaves the conditioning device at a temperature that is between an inlet temperature and a temporary maximum temperature.

20. The method as claimed in claim 14, wherein the global recirculating-air flow is passed, partially or at least approximately entirely, through one or more supplementary heating devices, and wherein the temperature of the global recirculating-air flow is thereby raised by at most approximately 20° C., optionally at most approximately 15° C., optionally without intermediate overheating and resultant conversion of substances contained in the recirculating-air flow.
